(19) United States
(12) Patent Application Publication
(10) Pub. No.: US 2006/0136270 A1
(43) Pub. Date: Jun. 22, 2006

(54) Medical claim data transfer to medical deposit box and/or medical visit record

(76) Inventors: John David Morgan, Saratoga Springs, UT (US); Charles Russell Rhodes, Pleasant Hill, CA (US); Paul Hubert Warner, Alameda, CA (US); Mark C. Kozak, Wilson, WY (US); Kenneth E. Andam, Highland, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/292,576

(22) Filed: Dec. 2, 2005

Related U.S. Application Data
(60) Provisional application No. 60/637,051, filed on Dec. 16, 2004.
(60) Provisional application No. 60/724,151, filed on Oct. 6, 2005.
(60) Provisional application No. 60/724,124, filed on Oct. 6, 2005.

(51) Int. Cl. G06F 19/00; G06F 17/24

(52) U.S. Cl. 705/3; 715/530

(57) ABSTRACT

A method for generating a personal health record for a patient includes: providing a plurality of medical claim objects that are stored in a first format, the medical claim objects including medical claim codes indicative of medical claim events; and translating the medical claim objects from the first format into a second format to generate personal health record data. The personal health record can also include patient or practitioner entered data. The personal health record is portable and may be owned by the patient. Access to the personal health record can be given by a patient to a practitioner to the extent desired. The portable personal health record is stored in standard codes so that medical information, advertisements, queries, and the like can be readily translated to various reader levels to facilitate clear communication at the reader's education level and language.

### CROSS-REFERENCE TO RELATED APPLICATIONS

This application claims the benefit of U.S. Provisional Applications Nos. 60/637,051, filed Dec. 2, 2004 and entitled “Medical Claim Data Transfer to Medical Deposit Box and/or Medical Visit Record”; Ser. No. 60/724,151, filed Oct. 6, 2004 and entitled “Virtual Peer-to-Peer Communication that Enables a Patient-Practitioner Partnership in Healthcare”; and Ser. No. 60/724,124, filed Oct. 6, 2004 and entitled “Personal Health Monitor and Record”, each of which are incorporated herein by reference in their entireties.

### BACKGROUND OF THE INVENTION

1. The Field of the Invention

The present invention relates to the field of medical informatics. More particularly, the present invention relates to methods and systems for providing personal health records for patients.

2. The Relevant Technology

In 2002, the healthcare service sector was not only the largest industry in the US, but also the fastest growing. The US Department of Labor's Bureau of Statistics projects that 3.5 million jobs will be created in the field between 2002 and 2012. Information technology is the foundation of the healthcare revolution, and employment in the field of medical records and information technology is expected to increase 36% or more between 2002 and 2012.

While billions of dollars are being spent to make hospitals and doctors' offices interconnected and interoperable using Electronic Health Records (EHRs), the concept of Personal Health Records (PHRs) is still relatively new. The primary difference between the two is that the PHR was built to serve the patient and facilitate engagement of the patient with their healthcare provider and the EHR was built to serve the provider with or without the involvement of the patient. Healthcare in the US is and has been dominated by the provider and the qualities of the EHR reflect this relationship.

There is, however, much interest in the private sector and the government for the development and widespread adoption of PHRs. The PHR is seen as a way to aggregate, collect, and connect with a patient the medical and health information that will improve quality of care. Additionally, the PHR engages and educates the patient and creates transparency in the healthcare process, thus reducing healthcare costs through health literacy and the ability to detect fraud. Unfortunately, the existing PHR products on the market are both tied-to and dominated by the healthcare provider or they do not possess the interoperability and interconnectivity needed to maximize information exchange.

In 2002, the US Department of Health and Human Services (HHS) established the National Health Information Infrastructure (NHII) to improve quality of care and reduce medical errors and administration costs associated with healthcare. The adopted infrastructure was envisioned by Dr. Don Detmer, who also envisioned the Computer-Based Patient Record (CPR), which the EHR is based on. As illustrated in FIG. 1, the new infrastructure depicts three equal and intersecting domains: the Personal Health Domain, the Provider Health Domain, and the Population Health Domain.

Detmer and HHS both envisioned that quality of care could improve and cost reduced if a balanced communication and participation existed between the three domains. Legislation and bipartisan support are helping to empower the personal domain and help equalize the interaction between the three domains. For example, the Health Insurance Portability and Accountability Act (HIPAA), mandates that every patient has the right to an understandable copy of his or her own health records. In addition, President Bush set a goal for the Department of Health and Human Services (HHS): in 10 years every American will have an electronic PHR. Under the direction of the HHS, the Centers for Medicare and Medicaid Services (CMS) issued a Request for Information (RFI) on personal health records. CMS hopes to utilize PHRs to empower the patient with knowledge and resources to improve public health and reduce national healthcare costs.

The United States spends considerably more on healthcare per person than the next closest nation, yet it is ranked near the bottom of developed countries in citizen longevity and general good health. The solution to improve healthcare in the U.S., as suggested by Secretary Mike Leavitt of the U.S. Department of Health and Human Service, is fivefold: (1) encourage wellness and preventive healthcare; (2) create transmission and vocabulary standards for efficient information exchange; (3) align payment structure to reward for wellness and eliminate fraud and abuse; (4) reduce medical errors by improving education and access to information; and (5) give people the capability to control their medical records. (Secretary Mike Leavitt, Department of Health and Human Services, Stanford Medical School Public Policy Forum Series, May 23, 2005.

Accordingly, what are needed are independent and objective systems to help patients and practitioners more effectively communicate and to help patients have an easily accessible health record.

### BRIEF SUMMARY OF THE INVENTION

The present invention overcomes the foregoing problems by developing an interactive medical and health information system that is designed for the patient. Technologically, the system is the equivalent or counterpart to the healthcare provider's Electronic Health Record (EHR) system, except built to independently and objectively meet the needs of a patient. Fundamentally, the system allows patients to aggregate, own, manage, and better understand their medical and health history, current status, and likely future. The inventive Personal Health Record (PHR) system is built on the core concept that a PHR needs to be a living (real-time) management system that automatically collects medical records through medical claims transfers, translates them for the patient, and then employs interactive functions and decision-making engines to deliver additional personalized information to the user. The concept encourages patients to build a proactive and cooperative relationship with their healthcare provider, rather than assuming a purely dependent one. The added benefit of a PHR system that engages and educates the user is that it helps to create transparency which can potentially reduce fraud and medical errors.

Accordingly, a first example embodiment of the invention is a method for generating a personal health record for a patient. The method generally includes: providing a plurality of medical claim objects that are stored in a first format, the medical claim objects including medical claim codes indicative of medical claim events; and translating the medical claim objects from the first format into a second format to generate personal health record data.

A second example embodiment of the invention is a method for providing automated health advice for a patient. This method generally includes: providing a personal health database stored on at least one data storage device, the personal health database including health data translated from coded provider diagnoses and procedures coded on medical claim forms; defining a plurality of nodes corresponding to event triggers or medical problems, wherein each node designates through rules or algorithms one or more recommended activities to be performed or suggested upon the occurrence of an event trigger or problem; and upon receiving data indicative of an event trigger or problem for a patient: identifying one or more nodes to be acted upon and selecting one or more activities to be suggested; referencing the personal health manager to identify any medical and health data that is relevant to the activities to be suggested, and if necessary, modifying the suggested activities; and presenting the suggested activities as medical/health advice, queries, or suggestions to a patient or practitioner.

A third example embodiment of the invention is a method for communicating medical information to a patient. The method generally includes: providing a personal health record containing information indicative of a patient's medical history, the personal health record containing information about the patient's education, literacy and/or language; upon receiving a request from a user to access the patient's medical history, translating codes indicative of the personal health record data into user readable text that describes the medical service provided and is at a reading level appropriate to a profile defined for the user; and presenting the user readable text at the appropriate reading level.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a health infrastructure including three intersecting domains: the Personal Health Domain, the Provider Health Domain, and the Population Health Domain.

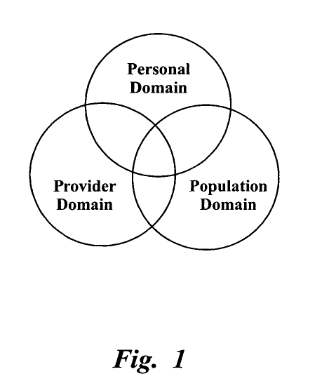

### DETAILED DESCRIPTION OF THE PREFERRED EMBODIMENTS

The present invention includes an interactive medical and health information system that is designed for the patient. Embodiments of the invention generate a personal health record by converting medical claim objects that are stored in a first format or protocol into a second format or protocol that is more clinical in nature and allows for the recordation of much more information. The medical claim objects include medical claim codes indicative of medical claim events that can then be added to patient's medical history. The personal health record is portable and may be owned by the patient. Access to the personal health record can be given by a patient to a practitioner to the extent desired. The portable personal health record is stored in standard codes so that medical information, advertisements, queries, and the like can be readily translated to various reader levels to facilitate clear communication at the reader's education level and language.

In order to build a system that facilitates trustworthy and clear information exchange between the doctor and the patient, The PHR system is built to standards that promote communication and knowledge through interoperability and interconnectivity with EHR systems. The technology and capability is guided by principles outlined by the American Medical Informatics Association (AMIA) as the primary features that must be met so that healthcare providers will trust a PHR. These include: integrity; standard terminology; time stamps; withheld data flags; non-repudiation; authentication; and encryption. The significance of the application of guidelines or ideals to the PHR system is that these ideals were generated by the healthcare community as the foundation of a trustworthy electronic medical record system and are still not widely implemented by the provider community. The following discussion of the invention outlines how the invention generates a PHR, denotes how the PHR can be used, and identifies inventive ways in which the PHR can be used to improve patient-practitioner communication.

A. Personal Health Record Generation

Under The Health Insurance Provider and Accountability Act of 1996 (HIPAA), medical providers and insurers are currently required to record claims using a standardized set of medical claim codes. These codes are not textual nor are they readily understandable by either practitioners or patients. A first aspect of the invention provides methods for generating personal health records from the medical claim codes used by processors, insurers and providers to record claims. The codes can then be translated to lay terminology when patients wish to review their histories. The personal health records can be made available to individuals at their convenience on-line or in print version.

The Office of the National Coordinator of Health Information Technology (ONCHIT) has established standards for interconnectivity among members of the provider domain using standards developed by HL7 (Health Level 7—a nonprofit attempting to set standards for personal health records). Troublingly, there is no single mandated standard transmittal in use by the provider community—(version 2.7, which is already supplanted by version 3.x, is in use by less than 15% of providers, an even then often as an attachment to a claim transmittal.

These claim transmittals are part of the claim process between payers and providers and conform to standards in use for years for financial transactions between businesses. The Health Insurance Provider and Accountability Act of 1996 (HIPAA) has provided in its standards for the transmittal of health insurance claims to be exchanged via X12N.837 protocols. These claim protocols are in turn mandated as interconnectivity standards by ONCHIT. The patient privacy provision (taking effect in 2004, and in 2006 for small providers) has recently been added to HIPAA and mandates that patients have the right to inspect/copy their medical and financial records held by providers or covered entities.

The claims for services UB92 (institution) or the CMS 1500 (professional) in their manual form or the electronic standard X12N.837 form contain the summary of medical and financial information HIPAA requires to be shared with patients. HIPAA requires at least a copy of the record be given the patient, but would prefer/accept a summary/explanation on media preferred by the patient if not too expensive and approved by the patient. Electronic copies in the standard electronic format approved by ONCHIT via the web are very inexpensive compared to paper copies.

According to the invention, translators embodied in hardware and software can be used to convert the claim format to that of the schema of a personal health management system. In other words, medical information attached to claims data can be extracted using a translation database to populate a personal health record. Although this data may be less complete that direct medical data recordation, it provides a relatively inexpensive and potentially automated process to create medical histories. Regardless, the content of the claim can be operated upon to make content objects unique to the transmission protocol and content into ONCHIT standard content.

The initial claim is in episodic format meaning that all content is for a single visit/episode to a doctor or hospital and is devoid of context of the health of the patient. Typically, the claim has been in a form that has not been suitable for use in a health management system where data over many episodes and for a lifetime is recorded on a single patient. Embodiments of the invention transform the data from the claim via the schema into a database that is patient focused rather than provider/payer focused. This data can then be stored and compiled longitudinally (multiple episodes over a lifetime) and partitioned into groups of related objects for presentation and decision making - a database to support a personal health management system.

Preferably, information from the claim identifying the source, purpose and credentials is stored with each newly transformed data element saved in the longitudinal, partitioned database.

One example of a claim code that can be translated is ICD9CM. ICD9CM is a clinical/administrative code (paid for and licensed by the government) created by the WHO and used on claim forms by a hospital (UB-92) or doctor's office (CMS-1500). ICD9CM has 15,000 codes for 700,000 diseases. Other example claim codes include CPT®, HCPCS, and E/M. CPT® is an American Medical Association code that focuses on medical procedures which doctor's office are required by the government to use and pay a license fee for.

An example of a code into which the claim codes can be translated is SNOMED-CT. SNOMED-CT is a clinical code that can be used according to the invention for structured data entry apart from the translated claim codes. SNOMED-CT is a nomenclature type of code that is paid for and licensed by the government and was created by NHS (in the UK) and the College of American Pathologists (CAP). SNOMED-CT is less limited than ICD9CM in that an unlimited combination of roots can create a code for any condition. Thus, SNOMED-CT is a more specific code than ICD9CM and is becoming more prevalent over time. By way of example, the inventive systems can use SNOMED-CT code to indicate specific symptoms such as “drowsiness” or “slurred speech.” ICD9CM is not this specific. Another example of a structure into which the personal health record can store data is XML. Other code examples will be readily apparent to those skilled in the art.

In addition to generating medical history data by importing claim codes, structured data entry can be used for patient and doctor documentation and code generation. Currently, practitioners must manually document patient signs and symptoms; these factors are then applied to a weighted rules calculator in order to determine the most applicable reimbursement code (CPT® E/M code). The process is time consuming, tedious, and increases the potential for billing and medical errors. The doctor can also be charged with fraud if there is not adequate documentation to derive E/M and other reimbursement codes. Patients also have difficulty remembering all their symptoms and doctors have difficulty acquiring a comprehensive data set of signs and symptoms in order to make an accurate diagnosis. Currently, there is an additional disconnection between the clinical code set, SNOMED-CT, designed for clinical documentation, and the reimbursement code set.

The invention includes a process for patients to thoroughly document their symptoms outside the practitioner environment. The system employs a structured data entry system which guides the patient through the documentation process, creates a historical record of symptoms (in SNOMED-CT codes), converting the symptoms into the corresponding clinical terminology. The coded clinical information is documented and can be sent to the practitioner, at the patient's approval, as an electronic file. These steps alone benefit the doctor and patient. Time is saved for doctor and patient, codes are verified for the doctor, documentation error is reduced, and a more comprehensive set of symptoms is available to make the best diagnosis. As a function that is only accessible for the treating practitioner in the inventive management system, the practitioner also has the ability to select the prevalence of each symptom to algorithmically determine a potential diagnosis and correspondingly mapped reimbursement code. More comprehensive queries can also be run. The system can also be used to present the patient or practitioner with lay and clinical definitions of symptoms.

It is very important that the data in the PHR be credible to practitioners and patients alike. A person's ability to place value on a piece of information is highly dependent on the source of the information and the credibility of the source. The invention includes a system that can be incorporated in any coding language to link the contents of the PHR with a source and an accompanying credibility rating-system. The SNOMED-CT and the US Department of Labor have a code specifically to describe all roles and specialties for all specialties. Other codes are also available to describe the concept that someone is not of the medical profession although the individual's profession may imply a certain level of likely or potential understanding. The ability to assign a code to a source's authority-level defines credibility.

Data integrity is established through qualifying attributes within the code string. Each piece of medical and health data is linked to a “source code” and a “credibility code.” For the purposes of demonstrating the concept, following examples are presented using a tag string. For example, the source code can identify a practitioner while the credibility code identifies the education or background of the person supplying the information, form example: doctor, engineer, nurse, etc. The credibility code can apply to anyone that records the data, not just patients or practitioners.

Through the coding process of linking a source of information and credibility of the source to the data within a PHR, the data within a PHR acquires integrity so the doctor can value and trust the information within the PHR.

In order to maintain the highest level of integrity, various embodiments of the invention provide that data can never be erased, only crossed out so that it is not always visible. Data can only be changed or modified by the source of the data. The authentication process limits who accesses and modifies the data with the PHR system.

The PHR preferably has all data within the system has time stamped. When data is entered into the PHR, the system records the time when that data entered the system. System time (the system date/time a record is entered into the data base) is the ultimate time used for non-repudiation, as well for establishing the latest time limit on estimated dates. The system also inquires and records other time data associated with the medical or health data which can be analyzed for potential significance by a provider at a future time. The time stamp appears as an attribute of the code string and stored with its associated data within a coded database.

B. Personal Health Manager

The concept of a personal health manager (PHM) (organizes, monitors, and advises) built into an electronic personal health record (PHR). The PHM uses codes derived from medical claims to query medical information, health information, and health rules to advise the user on personally relevant health-related decisions. The information and rules that create the logic of the PHM are updated by the electronic claims data, knowledge-base workers, patients, and computer-based sources.

The PHM can then be used to recognize medical problems or “event triggers” ranging from therapeutic and preventive health suggestions, to negative drug interactions, to medical recalls, to clinical trials, to alerts and reminders, to direct-to-consumer advertising. The PHM is able to direct relevant information to the user by using “nodes” to monitor or implement activities based upon data in the PHR. These subject-based nodes contain rules and algorithms that govern the dissemination of certain types of information to the user. Depending on certain data and combinations of data, the nodes will trigger the automated selection of rule-based activities.

The inventive personal health record can be used to align consumers with services in a number of ways. Because a user's health characteristics are described using coded concepts, it is possible to cross reference or match a user's health characteristics with a service or product characteristics. The end result is the ability to connect a user with a product or service that is specifically pertinent to the user.

For example, embodiments of the invention include a technique to improve direct-to-consumer advertising and to conduct it in a way that maintains privacy for the user. The system identifies products whose characteristics match the codes associated with the user's health characteristics. The system discreetly notifies the user that a product exists that relates to user's specific needs. The user is then able, at their discretion, to contact the advertiser or link to the advertiser's website.

Clinical trials can also be matched with appropriate subjects based on coded health characteristics exhibited by the user. According to the American Cancer Society, the largest barrier to performing effective clinical studies is finding the right people to participate in them. Every year hundreds of new clinical studies are initiated with the costs of finding the right participants ranging from hundreds to thousands of dollars per participant. At the same time that many research groups and pharmaceutical companies are looking for subjects to participate in their studies, individuals are looking for studies that might help them solve their healthcare dilemmas. The inventive systems can be used to provide a direct, efficient, and respectful way for the parties to find each other.

Another example of services that can be provided are ratings directed to doctors, hospital, clinics, medical procedures as defined by medical supplier or technique, and the like. By associating coded concepts with a user's health characteristics, it is possible to conduct satisfaction and quality surveys that reflect the user's specific experiences and health situation. Whereas traditional surveys are now focused surveys, the invention can generate survey sets that are specific to a patient's diagnoses and treatment. It is now also possible for patients to participate in quality surveys in addition to satisfaction surveys, because patient are now appropriately educated on diagnoses and procedures. Additionally, it becomes possible for patients with a needed procedure to search locally for doctors, hospitals, etc. with good ratings. The systems can use survey standards set by the government to create objective comparison data sets.

The inventive personal health record can also be used to connect users with other users. By describing a user's health status using coded concepts, it is possible to efficiently connect users with other users who share the same health characteristics. For example, a forum can be established where users who share similar concerns, conditions, providers, etc. can connect with each other to discuss issues.

Although it is for the patients to be able to control who views their personal data as well as which data is viewed, it is also important for doctors to have trust in the PHR as a trustworthy mechanism for facilitating the providing of healthcare. To increase the doctor's trust in the system, all withheld data can be flagged to let the doctor know that information has been withheld, even if they do not know precisely what was withheld. The invention flags all withheld data buts helps the doctor qualify the importance of the data by associating and source code, credibility code, subject code, and system date with the flagged data. This allows the doctor some insight into as to how critical and reliable the information may be in regard to the patient's immediate and future health. The code sets used to create the credibility codes can be generated from SNOMED-CT (or the US Dept. of Labor Codes therein), for example, and the subject codes can be generated from any of the standard terminologies, for example.

The inventive system also notifies the sender when the system has received the data, with the qualifier that the ultimate recipient of the information has not necessarily viewed the information. Once the system has notified the recipient that new information has been received by the system and the recipient opens the sender's file, the system sends a notice to the sender.

For security, the present invention can also use authentication and encryption methods. Currently, the authentication system that is employed by virtually all authentication systems has the authentication process occurring inside the “live” database where sensitive and personal data are stored. If an attacker is able to override the authentication with repeated attacks, the attacker ends up inside the “live” database. According to the invention, a new authentication system has the user logins within a benign environment rather than within a live one. When the user initiates the authentication process, the system kicks the user over to a “mirror” server where the authentication is verified. Once authentication is verified, the mirror database directs the user into the live database that has access to the invention's personal health management system.

If the attacker is able to override the authentication process, the attacker only has access to the mirror database which does not have any personal or proprietary information within it. The mirror database records the IP address, hard drive serial number, and location of both the authenticated user and the attacker who manages to break into the mirror database.

In addition, in embodiments of the invention the user can set the level of security and the level of security can be changed whenever the user desires. But increasing security also increases inconvenience, and the user must decide the level of access and how much inconvenience they will tolerate. The invention can allow the owner of the PHR to define this granularity. The invention can also assure PHR users that information is adequately protected by using state-of-the-art security and privacy protocols for firewalls, encryption, and authentication.

The user can also authorize and define classes of users or individuals who have access to the individual's PHR. A real value of the PHR is the ability of doctors and emergency personnel to access the individual's records so as to be able to provide the best level of care and reduce the possibility of medical errors. Emergency personnel can access the individual's emergency record of the PHR with a validated Unique Provider Identification Number (UPIN). Vendors can validate whether the UPIN is a legitimate number but vendors cannot validate that the provider is who they say they are. But one way of mediating this problem is by auditing those who access the PHR. This provides some level of accountability.

The most common and basic type of authentication is the use of a username and password. This type of authentication usually occurs at the time the account is initially accessed or a session is begun. A second level of username and password authentication can also occur anytime the user receives an update or any level of information is exchanged with the user. This second level of authentication is determined by the owner.

A problem with password authentication is that users often have a difficult time remembering passwords and creating new ones on a regular basis. An authentication solution to remembering passwords is responsive or knowledge response authentication. With this type of authentication, the user is asked a series of random questions with personalized answers that are defined when the account is originally established. With this type of authentication, answers are also weighted to ensure that the user is authorized. Preferably, all data/records cite an author and only the author can modify those data/records. This authoring and auditing concept maintains record integrity.

Embodiments of the invention preferably use encryption technology. The type and degree of encryption can be modified as appropriate to the particular protected content, decision logic, or transmission setting. Because any encryption slows decision making, only those data elements containing personal identifiers receive the highest levels of encryption. Other elements contain coded content and need not be encrypted except for the source identifier, which is encrypted. If less than maximum encryption is used an unauthorized individual may get access to portions of content, but they will have no understanding of the meaning without also having the data dictionary, which is in the static portion of the database under the utmost encrypted security. This is a workable solution balancing speed and privacy.

By way of example only, the present invention can use firewalls (physical and logical access security), encryption (also including connection security using secure socket layer (SSL)), authentication (only an authorized person can access the PHR), and proprietary codes (a layer of proprietary information that has no meaning to an intruder).

C. Interoperability

Embodiments of the invention preferably employ standard terminology that is consistent and can be easily translated to adapt to the user. Standard terminology for healthcare providers has and will be continued to be established through the Office of the National Coordinator for Health Information Technology (ONCHIT) which includes the separately established, Health Insurance Portability and Accountability Act (HIPAA) standards. Before the present invention, these vocabularies have only been used by providers and not by consumers.

The invention includes a mechanism for facilitating and leveling communication between providers and consumers through the translation to standard terminology. Creating a mechanism for consumers to use standard vocabularies allows a PHR to be automatically populated with provider-derived data through the medical claims form. The use of standard vocabularies, however, more so ensures the accurate communication of clinical concepts, the facilitation of education and health literacy, the use of decision making engines by consumers to make better health-related decisions, and the ability for the consumer to accurately document concepts through structured data entry.

The inventive systems create an appropriate translation of a coded concept or standard terminology for clinicians as well as for lay persons. The translation is a function of the standard terminology, the name of the source of the data, and the credibility code. This approach makes it possible to create a clinical or lay translation from a standard code or determine the standard code based on a list of text phrases that are associated with a specific coded-concept. When a user selects a text phrase associated with a standard code, the user's credibility code gets bundled with the standard terminology so a reader knows who generated the coded-concept.

Currently, the readability of a certain document can be calculated by the word length (number of syllables) and the sentence length (number of words). The problem is, however, that readability does not necessarily guarantee understandability. To improve the understandability, the invention has a technique to calculate and create understandability based on a 5^{th} grade, 9^{th} grade, and college reading and understanding level. By inventorying and generating a histogram of the words used in the definitions in 5^{th} grade, 9^{th} grade, and college dictionaries, it is possible to adjust word usage to match the results of this statistical technique and better define understandability.

In another aspect of the invention, a diagnosis and reimbursement code generation engine can be used by practitioners. Such a system has software that enables a practitioner to select a fixed number of symptoms (variables) for the diagnosis engine to search for a list of potential diagnoses with corresponding reimbursement codes. The system allows a practitioner to “weight” symptoms differently depending on their prevalence.

Embodiments of the invention include or are incorporated in computer-readable media having computer-executable instructions or data structures stored thereon. Examples of computer-readable media include RAM, ROM, EEPROM, CD-ROM or other optical disk storage, magnetic disk storage or other magnetic storage devices, or any other medium capable of storing instructions or data structures and capable of being accessed by a general purpose or special purpose computer. Computer-readable media also encompasses combinations of the foregoing structures. Computer-executable instructions comprise, for example, instructions and data that cause a general purpose computer, special purpose computer, or special purpose processing device to execute a certain function or group of functions. The computer-executable instructions and associated data structures represent an example of program code means for executing the steps of the invention disclosed herein.

The invention further extends to computer systems adapted for use with distributed memory cells and related server technology, as described herein. Those skilled in the art will understand that the invention may be practiced in computing environments with many types of computer system configurations, including personal computers, multi-processor systems, network PCs, minicomputers, mainframe computers, and the like. The invention will be described herein in reference to a distributed computing environment, such as the Internet, where tasks are performed by remote processing devices that are linked through a communications network. In the distributed computing environment, computer-executable instructions and program modules for performing the features of the invention may be located in both local and remote memory storage devices.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating a personal health record for a patient, comprising:
providing a plurality of medical claim objects that are stored in a first format, the medical claim objects including medical claim codes indicative of medical claim events; and
translating the medical claim objects from the first format into a second format to generate personal health record data.

2. A method as defined in claim 1, wherein the personal health record data is stored in an ONCHIT standard format.

3. A method as defined in claim 1, wherein the personal health record data is stored in SNOMED-CT code.

4. A method as defined in claim 1, wherein the medical claim objects comprise data stored in the electronic standard X12N.837 protocol.

5. A method as defined in claim 1, further comprising:
receiving direct medical history data in a personal health record such that a patient has medical data stored in the personal health record that is derived from each of the medical claim objects and the direct medical history data; and
translating the medical claim objects and the received medical history data to a uniform data format for storage in the personal health record.

6. A method for generating a personal health record for a patient, comprising:
providing a personal health record comprising data generated by the method of claim 1; and
receiving health data from user entered information.

7. A method for generating a personal health record for a patient, comprising:
providing a personal health record comprising data generated by the method of claim 1; and
receiving health data derived from practitioner entered clinical information.

8. In a computing environment, a computer program product for implementing a method suitable for use in generating a personal health record for a patient, the computer program product comprising a computer readable medium carrying computer executable instructions for performing the method as defined in claim 1.

9. In a computing environment, a computer program product for implementing a method suitable for use in use in communicating symptoms from a patient to a practitioner, the computer program product comprising a computer readable medium carrying computer executable instructions for performing the method:
the acts as defined in claim 6, wherein the practitioner entered medical information is obtained by, with the patient's permission, receiving the personal health record from a personal health database such that the practitioner can access the personal health record to the extent authorized by the patient;
if necessary, translating the personal health record into a format compatible with the practitioner's electronic health record; and
adding the translated personal health record to the practitioner's electronic health record to generate an enhanced electronic health record, wherein the enhanced electronic health record enables a practitioner to view an enhanced data set of symptoms and medical history.

10. A computer program product as defined in claim 9, wherein the method further comprises the act of analyzing the enhanced data set of symptoms and medical history and providing a validated symptom history recommendation to the practitioner.

11. A method as defined in claim 1, further comprising the acts of:
storing the personal health record data in a centralized database comprising a personal health record, the personal health record aligning the personal health record data with the patient receiving the medical service that generated the medical claim;
upon receiving a request from a user to access the patient's medical history, translating the personal health record data into user readable text that describes the medical service provided and is at a reading level appropriate to a profile defined for the user; and
presenting the user readable text to the user at the appropriate reading level.

12. A computer program product as defined in claim 9, wherein the method further comprises the act, upon receiving directions from a practitioner, of generating text or a list of literature that are adapted to the appropriate reading level or language of the user.

13. A method for providing automated health advice for a patient, comprising:
providing a personal health database stored on at least one data storage device, the personal health database including health data translated from coded provider diagnoses and procedure coded on medical claim forms;
defining a plurality of nodes corresponding to event triggers or medical problems, wherein each node designates through rules or algorithms one or more recommended activities to be performed or suggested upon the occurrence of an event trigger or problem; and
upon receiving data indicative of an event trigger or problem for a patient:
identifying one or more nodes to be acted upon and selecting one or more activities to be suggested;
referencing the personal health manager to identify any medical and health data that is relevant to the activities to be suggested, and if necessary, modifying the suggested activities; and
presenting the suggested activities as medical or health advice, queries, or suggestions to a patient or practitioner.

14. A method as defined in claim 13, wherein the personal health database further comprises health data derived from user entered information.

15. A method as defined in claim 13, wherein the personal health database further comprises health data derived from practitioner entered medical information.

16. A method as defined in claim 13, wherein the event trigger is selected from the group consisting of: an advertiser request for direct-to-consumer advertising, the identification of a clinical trial seeking participants with characteristics matching those of the patient, a request for a rating (per specific medical conditions/procedures) directed to one or more of doctors, hospitals, and clinics, and the recommendation of a peer group having medical conditions similar to that of the patient.

17. In a computing environment, a computer program product for implementing a method suitable for use in generating a personal health record for a patient, the computer program product comprising a computer readable medium carrying computer executable instructions for performing the method:
the method as defined in claim 14, wherein the act of providing at least one data storage device comprising a personal health database including health data derived from user entered information comprises obtaining health data derived from user entered information by:
at a data computing device, directing a patient to enter symptom data indicative of symptoms or medical conditions pertaining to the patient;
converting the symptom data into SNOMED-CT code; and
storing the SNOMED-CT code in the personal health record to create a historical record of the symptoms.

18. A method for communicating medical information to a patient, comprising:
providing a personal health record containing information indicative of a patient's medical history, the personal health record containing information about the patient's education, literacy and/or language;
upon receiving a request from a user to access the patient's medical history, translating codes indicative of the personal health record data into user readable text that describes the medical service provided and is at a reading level appropriate to a profile defined for the user; and
presenting the user readable text at the appropriate reading level.

19. A method as defined in claim 18, wherein the user is the patient.

20. A method as defined in claim 18, wherein the user is a medical practitioner.
